(19) United States
(12) Patent Application Publication
(10) Pub. No.: US 2010/0023549 A1
(43) Pub. Date: Jan. 28, 2010

(54) METHOD AND APPARATUS FOR SOCIAL TAGGING USING PROPERTY FIELD OF ONTOLOGY OBJECT

(75) Inventors: Miran CHOI, Daejeon (KR); Jeong Heo, Daejeon (KR); Myung Gil Jang, Daejeon (KR); Hyunki Kim, Daejeon (KR); Yi Gyu Hwang, Daejeon (KR); Chung Hee Lee, Dejeon (KR); Soojong Lim, Daejeon (KR); Hyo-Jung Oh, Daejeon (KR); Chang Ki Lee, Daejeon (KR); Yeo Chan Yoon, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/417,232

(22) Filed: Apr. 2, 2009

(30) Foreign Application Priority Data
Jul. 22, 2008 (KR) 10-2008-0071389
Dec. 16, 2008 (KR) 10-2008-0127706

(51) Int. Cl. G06F 17/30

(52) U.S. Cl. 707/102; 707/E17.002; 707/E17.055; 707/E17.014; 707/103 R; 707/3

(57) ABSTRACT

A method for social tagging using a property field of an ontology object includes: selecting an object in an ontology database storing therein objects in forms of classes; selecting a property field in a class corresponding to the selected object; and adding a social tag by storing user's input as a value of the selected property field. Classes stored in the ontology database may have property fields defined when instances of the classes are created, and specific values may be stored as values of the property fields also when the instances are created. The property fields defined when the instances are created are classified into data type property fields and object type property field, and the selected property field is a data type property field.

### CROSS-REFERENCE(S) TO RELATED APPLICATION(S)

The present invention claims priority of Korean Patent Application No. 10-2008-0071389, filed on Jul. 22, 2008, and Korean Patent Application No. 10-2008-0127706, filed on Dec. 16, 2008, which is incorporated herein by reference.

### FIELD OF THE INVENTION

The present invention relates to a method and apparatus for social tagging using a property field of an ontology object; and, more particularly, to a method and apparatus for social tagging using a data type property field of an MPEG (Moving Picture Experts Group) media value chain ontology object.

### BACKGROUND OF THE INVENTION

As well known in the art, MPEG media value chain ontology is a systematic information resource for storing information relating to media intellectual property and using the stored information in various applications. In the MPEG media value chain ontology, various media related information, e.g., persons associated with intellectual property, intellectual property objects, actions and roles of the persons and the like, is stored to be used in various applications, e.g., in searches.

With respect to the media intellectual property, social tagging is of importance in that useful information can be obtained from various information sources.

Accordingly, in consideration of current environment in which semiconductor and information telecommunications technologies are rapidly developed, development of a method and apparatus for adding a social tag using a data type property field of an MPEG media value chain ontology object to ontology for intellectual property management is needed.

### SUMMARY OF THE INVENTION

In view of the above, the present invention provides a method and apparatus for social tagging using a data type property field of an MPEG media value chain ontology object, thereby adding a social tag to ontology for intellectual property management.

In accordance with an aspect of the invention, there is provided a method for social tagging using a property field of an ontology object, the method including:

selecting an object in an ontology database storing therein objects in forms of classes;

selecting a property field in a class corresponding to the selected object; and

adding a social tag by storing user's input as a value of the selected property field.

In accordance with another aspect of the invention, there is provided an apparatus for social tagging using a property field of an ontology object, the apparatus including:

an object selection unit for selecting an object in an ontology database storing therein objects in forms of classes;

a property field selection unit for selecting a property field in a class corresponding to the selected object; and

a social tag input unit for adding a social tag by storing user's input as a value of the selected property field.

According to the present invention, social tagging using a data type property field of an MPEG media value chain ontology object is performed to add a social tag to ontology for intellectual property management. That is, with respect to the media intellectual property, useful information is obtained from various information sources and added to the ontology for intellectual property management. Therefore, information corresponding to various demands of users can be managed to be used in various applications.

### BRIEF DESCRIPTION OF THE DRAWINGS

The above features of the present invention will become apparent from the following description of embodiments, given in conjunction with the accompanying drawings, in which:

FIG. 1 illustrates a block diagram of a social tagging apparatus using a property field of an ontology object in accordance with an embodiment of the present invention;

FIG. 2 illustrates a block diagram of hierarchical relationship between an object, a data type property and a social tag; and

FIG. 3 illustrates an exemplary hierarchy view of an instance of an ontology object.

### DETAILED DESCRIPTION OF THE EMBODIMENT

Hereinafter, embodiments of the present invention will be described in detail with reference to the accompanying drawings, which form a part hereof.

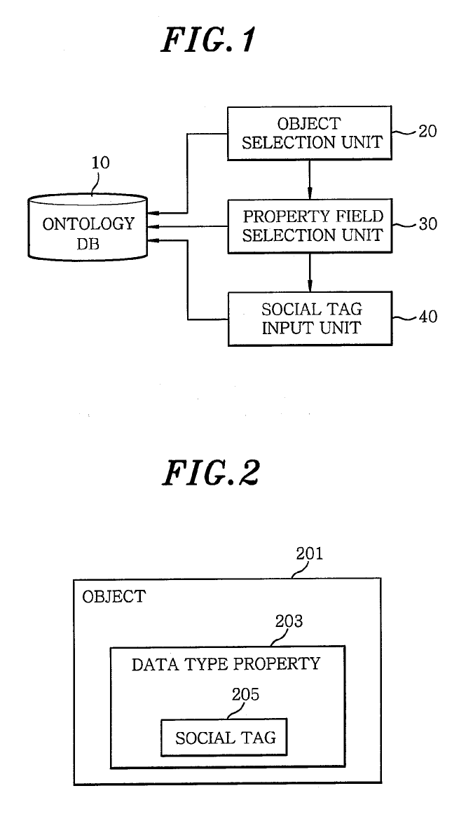

FIG. 1 illustrates a block diagram of a social tagging apparatus using a property field of an ontology object in accordance with an embodiment of the present invention. The social tagging apparatus may include an ontology database (hereinafter, simply referred to as “ontology DB”) 10, an object selection unit 20, and a property field selection unit 30 and a social tag input unit 40.

The ontology DB 10 is a database for MPEG media value chain ontology and stores therein various media related information, e.g., persons associated with intellectual property, intellectual property entities, actions and roles of the persons and the like, to use the stored information in various applications, e.g., in searches. In the ontology DB 10, objects are stored in forms of classes, and property fields for storing information relating to the object may be defined in each of the classes when instances of the classes are created. Further, specific values may be stored as values of the property fields also when the instances are created. Examples of classes relating to intellectual property are user classes, user's action classes, IP (Intellectual Property) entity classes, IP right classes, IP license classes and the like.

The object selection unit 20 selects an object to which social tags are to be added among the objects stored in the ontology DB 10, and provides the property field selection unit 30 with an object selection complete message to notify that the object is selected.

The property field selection unit 30 selects, in response to the object selection complete message from the object selection unit 20, a property field in a class corresponding to the selected object, and provides the social tag input unit 40 with a property field selection complete message to notify that the property field is selected.

The social tag input unit 40 adds, in response to the property field selection complete message from the property field selection unit 30, a social tag by storing user's input as a value of the selected property field.

Table 1 illustrates an exemplary class “Distributor” and properties thereof. The class “Distributor”, which is a subclass of a class “User”, represents a user who distributes intellectual property entities and is defined as “A User who distributes a Product”. The class “Distributor” includes object type properties “Is_identified_by”, “Has_role_of”, “Do_action” and “Has_IP” and a data type property “Has_social_tag”. Here, the data type property “Has_social_tag” is used for adding a social tag.

TABLE 1
E2-4 Distributor

Subclass of: User
Scope note: A User who distributes a Product
Properties:
Is_identified_by: String
Has_role_of: Distributor_role
Do_action: Distribute (lend, rent or sell)
Has_IP: IP Entities
Property note: this property is inherited from User.
Has_social_tag: String

FIG. 2 illustrates a block diagram of hierarchical relationship between an object, a data type property and a social tag.

As shown in FIG. 2, a social tag 205 is stored in the ontology DB 10 as a value of a data type property 203 in an object 201. Further, the data type property 203 may have sub-properties to hierarchically store various information.

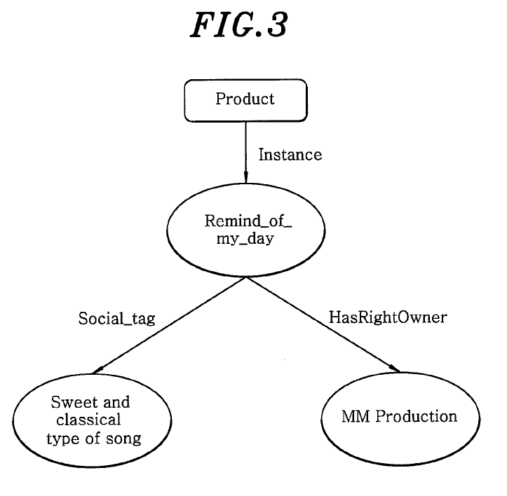

FIG. 3 illustrates an exemplary hierarchy view of an instance of an ontology object.

Referring to FIG. 3, an object “Remind_of_my_day” representing a song entitled “Remind of my day” is an instance of an IP entity class “Product”, and has two property fields “Social_tag” and “HasRightOwner”. The property field “Social_tag” is a string type property field representing a user's commentary, i.e., a social tag, on the song, and in this example, the commentary is “Sweet and classical type of song”. The property field “HasRightOwner” is an object type property field representing an owner of intellectual property rights with respect to the song, and in this example, the owner is “MM Production”.

Table 2 illustrates RDF (Resource Description Framework) representation of the example of FIG. 3.

TABLE 2

```
<rdf:RDF>
  <Producer rdf:ID=”MM_Production”>
    <isRightsOwnerOf>
      <Product rdf:ID=”Remind_of_my_day”>
        <hasSocialTag
rdf:datatype=”http://www.w3.org/2001/XMLSchema#string”>
          Sweet and classical type of song</hasSocialTag>
        <hasRightsOwner rdf:resource=”#MM_Production”/>
      </Product>
    </isRightsOwnerOf>
  </Producer>
</rdf:RDF>
```

The MPEG media value chain ontology can be represented in a machine-readable language, e.g., OWL (Web Ontology Language). However, since the MPEG media value chain ontology can be easily converted into other languages, e.g., XML (Extensible Markup Language), RDF and the like, the data type property (social tag property) of the present invention can be used independent of the languages.

If the MPEG media value chain ontology stored in a database is represented in, e.g., OWL, the ontology is parsed by using an OWL parser to obtain the social tag properties. Then the social tag properties are analyzed by using a semantic analyzer and the analysis result is used in various applications.

Below a social tagging method in accordance with an embodiment of the present invention will be described with the example of FIG. 3.

First, the object selection unit 20 selects, among objects stored in the ontology DB 10, the object “Remind_of_my_day”, to which a social tag is to be added, as an instance of an IP entity class “Product”. When the selection is completed, the object selection unit 20 provides the property field selection unit 30 with the object selection complete message to notify that the object “Remind_of_my_day” is selected.

Then, the property field selection unit 30 selects, in response to the object selection complete message from the object selection unit 20, the property field “Social_tag” for storing information relating to the selected object “Remind_of_my_day”. When the selection is completed, the property field selection unit 30 provides the social tag input unit 40 with the property field selection complete message to notify that the property field “Social_tag” is selected.

The social tag input unit 40 adds, in response to the property field selection complete message from the property field selection unit 30, a social tag by storing a user's input “Sweet and classical type of song” as a value of the property field “Social_tag”. As for the property field “HasRightOwner”, the value “MM Production” may be selected and stored when the instance is created.

According to the present invention, social tagging using a data type property field of an MPEG media value chain ontology object is performed to add a social tag to ontology for intellectual property management. That is, with respect to the media intellectual property, useful information is obtained from various information sources and added to the ontology for intellectual property management. Therefore, information corresponding to various demands of users can be managed to be used in various applications.

While the invention has been shown and described with respect to the embodiments, it will be understood by those skilled in the art that various changes and modification may be made without departing from the scope of the invention as defined in the following claims.

What is claimed is:

1. A method for social tagging using a property field of an ontology object, the method comprising:
selecting an object in an ontology database storing therein objects in forms of classes;
selecting a property field in a class corresponding to the selected object; and
adding a social tag by storing user's input as a value of the selected property field.

2. The method of claim 1, wherein classes stored in the ontology database have property fields defined when instances of the classes are created, and specific values are stored as values of the property fields also when the instances are created.

3. The method of claim 2, wherein the property fields defined when the instances are created are classified into data type property fields and object type property field, and the selected property field is a data type property field.

4. The method of claim 1, wherein the user's input is strings of commentary on the selected object.

5. An apparatus for social tagging using a property field of an ontology object, the apparatus comprising:
an object selection unit for selecting an object in an ontology database storing therein objects in forms of classes;
a property field selection unit for selecting a property field in a class corresponding to the selected object; and
a social tag input unit for adding a social tag by storing user's input as a value of the selected property field.

6. The apparatus of claim 5, wherein classes stored in the ontology database have property fields defined when instances of the classes are created, and specific values are stored as values of the property fields also when the instances are created.

7. The apparatus of claim 6, wherein the property fields defined when the instances are created are classified into data type property fields and object type property field, and the selected property field is a data type property field.

8. The apparatus of claim 5, wherein the user's input is strings of commentary on the selected object.
